(19) United States
(12) Patent Application Publication
(10) Pub. No.: US 2005/0280731 A1
(43) Pub. Date: Dec. 22, 2005

(54) Apparatus and method for displaying images in a portable terminal comprising a camera and two display units

(75) Inventor: Moon-Heui Lee, Gumi-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/155,649

(22) Filed: Jun. 20, 2005

(30) Foreign Application Priority Data
Jun. 21, 2004 (KR) 2004-45954

(51) Int. Cl. H04N 5/222

(52) U.S. Cl. 348/333.01

(57) ABSTRACT

An apparatus and method are provided for displaying images in a portable terminal including a camera and two display units. The apparatus and method include, when a camera mode is selected, receiving an image, and displaying the received image on a first display unit and a second display unit. An image photographed in a portable terminal including a camera is displayed on a first display unit positioned at the inner side of the portable terminal and a second display unit positioned at the outer side of the portable terminal such that the other party (a subject) as well as a user of the portable terminal may view the photograph state, thereby preventing repeated photograph attempts by the user based on the photograph state.

### PRIORITY

This application claims the benefit under 35 U.S.C. 119(a) of an application entitled “Method for Displaying Images in Portable Terminal Including Camera and Two Display Units” filed in the Korean Intellectual Property Office on Jun. 21, 2004 and assigned Serial No. 2004-45954, the entire contents of which are incorporated herein by reference.

### BACKGROUND OF THE INVENTION

1. Field of the Invention

The present invention relates to a method and apparatus for displaying images in a portable terminal. More particularly, the present invention relates to a method and apparatus for displaying images on a plurality of display units.

2. Description of the Related Art

Currently, portable mobile communication terminals are evolving into terminals having structures capable of performing high speed data communication in addition to voice communication. In other words, if a mobile communication network adaptable for an International Mobile Telecommunications (IMT) 2000 standard is realized, high-speed data communication as well as voice communication can be achieved by using the portable terminals. Herein, data processed in data communication by the portable terminals may include image data.

Currently, portable terminals equipped with cameras have been developed and are coming into the market. These cameras combined with the portable terminals may be classified into embedded cameras and external cameras. Portable terminals including the embedded cameras are becoming more popular.

Current portable terminals include the bodies thereof, the folders thereof having display units, and hinge units coupling the bodies with the folders. When the portable terminal including such an embedded camera photographs an image, the photographed image is displayed on a screen of the display unit, and a user of the portable terminal controls the position of the camera while viewing the image of the display unit. However, when the photographed image is displayed only on the inner display unit positioned at the inner side of the portable terminal, a person (a subject of the photograph) whose photograph is taken by the user cannot easily view the image on the display. In addition, when the photographed image is displayed only on the inner display unit, the user cannot easily view the image on the inner display without repositioning the mobile terminal. Therefore, the user must take a photograph several times in order to obtain a desired result.

### SUMMARY OF THE INVENTION

Accordingly, the present invention has been made to solve the above-mentioned problems occurring in the prior art, and an object of the present invention is to provide an apparatus and method for displaying a photographed image in a portable terminal comprising a camera.

To accomplish the above objects, there is provided an apparatus and method for displaying an image in a portable terminal comprising two display units. The apparatus and method comprising the steps of when a camera mode is selected, receiving an image, and displaying the received image on a first display unit and a second display unit.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating a structure of a portable terminal having first and second display units for displaying an image according to an embodiment of the present invention;

FIG. 2A is a flowchart illustrating a method for simultaneously transmitting an image to first and second display units in a portable terminal according to an embodiment of the present invention;

FIG. 2B is a flowchart illustrating a method for selectively sending an image to a first display unit and a second display unit in the portable terminal according to an embodiment of the present invention;

FIG. 3 is a flowchart illustrating a method for selectively sending an image to a first display unit or a second display unit based on changed address values in a portable terminal according to an embodiment of the present invention; and

FIGS. 4A and 4B are images illustrating a first display unit displaying an image in a right direction and a second display unit displaying a left-right reversed image in a portable terminal according to an embodiment of the present invention.

Throughout the drawings, the same element is designated by the same reference numeral or character.

### DETAILED DESCRIPTION OF AN EXEMPLARY EMBODIMENT

Hereinafter, an embodiment of the present invention will be described in detail with reference to the accompanying drawings. In the following description of the present invention, a detailed description of known functions and configurations incorporated herein will be omitted for conciseness.

In the following description of the present invention, descriptions about specific items such as a transmission rate and the size of a camera image signal and the size of an image signal of a display unit will be omitted. In addition, it is well known to those skilled in the art that the present invention can be easily embodied without such specific items or with the change of the specific items.

In the following description, a normal direction image refers to an image displayed in up, down, left, and right directions from a start address value of a display unit.

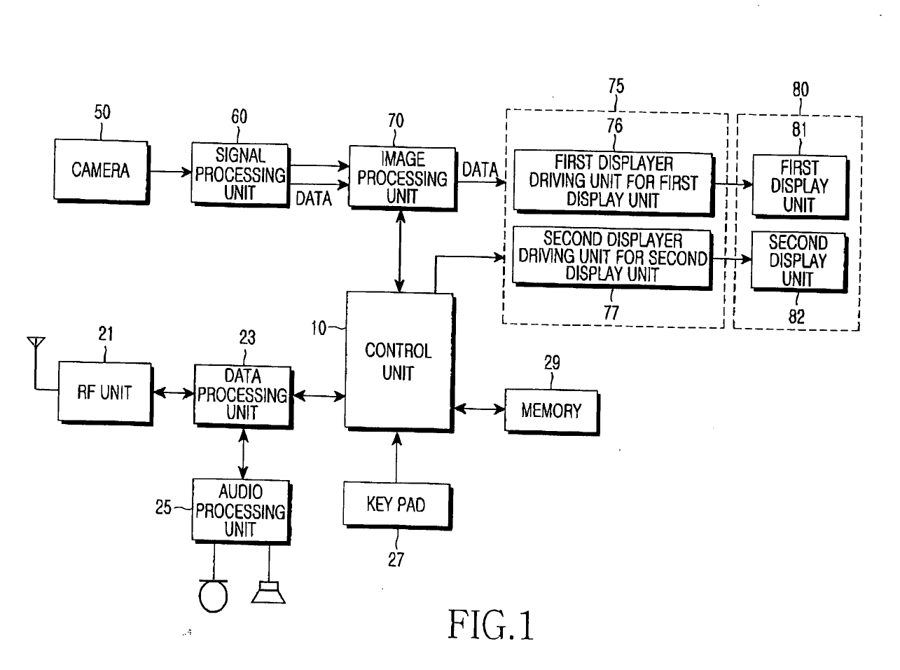

FIG. 1 is a block diagram illustrating a structure of a portable terminal having first and second display units for displaying images according to an embodiment of the present invention.

A radio frequency (RF) unit 21 comprises a RF transmitter (not shown) for up-ward converting and amplifying a transmitted signal and a RF receiver (not shown) for low-noise amplifying a received signal and down-converting a frequency of the received signal.

A data processing unit 23 comprises a transmitter (not shown) for encoding and modulating the transmitted signal and a receiver (not shown) for demodulating and decoding the received signal. That is, the data processing unit 23 may comprise a MODEM and a CODEC.

An audio processing unit 25 reproduces a received audio signal output from the data processing unit 23 or sends an audio signal generated from a microphone to the data processing unit 23.

A key pad 27 comprises keys for inputting numeral and letter information and function keys for setting a variety of functions. In addition, the key pad 27 may comprise a photographing key and a mode setting key used for photographing and displaying images and comprise a display mode key for a second display unit 82 used for outputting images to the second display unit 82 according to an embodiment of the present invention.

A memory 29 may comprise a program memory and a data memory. The program memory stores programs for controlling general operations of a portable telephone and a program allowing two display units to display image data received in a camera mode according to an embodiment of the present invention. The data memory temporarily stores data generated during execution of the programs.

A control unit 10 controls an overall operation of the portable telephone. In addition, the control unit 10 may comprise the data processing unit 23. When mode setting is changed through the key pad 27, the control unit controls a signal processing unit 60 such that a photographing mode may be set and an image photographed according to the setting may be displayed. In addition, the control unit 10 controls a path through which image data is transmitted to a first display unit 81 according to an embodiment of the present invention. When image data are output to a second display unit 82, the control unit 10 controls an image processing unit 70 to change a start address value of the image data output to the second display unit 82, so that an image symmetrical to the normal direction image is output.

A camera 50 photographs an image. The camera 50 comprises a camera sensor for converting an optical signal of the photographed image into an electrical signal. Herein, it is assumed that the camera sensor is a charge coupled device (CCD) sensor.

The signal processing unit 60 converts the electrical signal output from the camera 50 into a digital image signal. Herein, the signal processing unit 60 may be realized using a digital signal processor (DSP). The image processing unit 70 generates image data used for displaying the image signal output from the signal processing unit 60.

The image processing unit 70 sends an image signal (received under the control of the control unit 10) compatible with a display unit 80. In addition, the image processing unit 70 compresses or expands an image. The image processing unit 70 sends a start address value of an output image to the display unit 80 or changes and sets the start address to be sent under the control of the control unit 10.

The display unit 80 displays an image output from the image processing unit 70. The display unit 80 may employ a liquid crystal display (LCD). In this case, the display unit 80 may comprise a LCD controller, a memory capable of storing images, and a LCD device. Herein, when the LCD is realized using a touch screen scheme, the key pad 27 and the LCD may be constructed as input units. The display unit 80 comprises an image display unit for outputting an image.

The display unit 80 comprises the first display unit 81 and the second display unit 82. The first display unit 81 is positioned at an inner side of the portable terminal and displays an image based on a start address value sent from the image processing unit 70. The second display unit 82 is positioned on the surface of the portable terminal and displays an image based on a start address value changed, set, and sent in the image processing unit 70.

A displayer driving unit 75 drives the display unit 80 under the control of the control unit 10. The displayer driving unit 75 comprises a first displayer driving unit 76 for the first display unit and a second displayer driving unit 77 for the second display unit. The first displayer driving unit 76 drives the first display unit 81 under the control of the control unit 10, and the second displayer driving unit 77 drives the second display unit 82 under the control of the control unit 10.

Hereinafter, an operation of the portable telephone will be described with reference to FIG. 1. If a user sets a call origination mode by dialing on the key pad 27 in order to originate a call, the control unit 10 detects the call origination mode, processes dialed information received through the data processing unit 23, and then converts the dialed information into a RF signal to be output through the RF unit 21. Thereafter, when the other party of the call generates a response signal, the control unit 10 detects the response signal through the RF unit 21 and the data processing unit 23. Then, a speech path is formed by means of the audio processing unit 25 so that the user may communicate with the other party. In a call termination mode, the control unit 10 detects through the data processing unit 23 that the call termination mode is set and then generates a ring signal through an audio signal processing unit 25. Thereafter, if the user responds to the ring signal, the control unit 10 detects the response and performs communication by forming a speech path through the audio signal processing unit 25. Herein, although voice communication is described in view of both the call origination mode and the call termination mode by way of example, data communication employed for processing packet data and video data can be performed in addition to the voice communication. In a waiting mode or in text communication, the control unit 10 displays text data processed through the data processing unit 23 on the display unit 80.

In the meantime, the portable terminal can perform an operation of photographing persons or surroundings so as to display or transmit photographed persons or photographed surroundings. Herein, the camera 50 may be mounted on the portable telephone or connected to an external position. In other words, the camera 50 may be an embedded camera or an external camera. The camera 50 may employ the CCD sensor. An image photographed by the camera 50 is converted into an electrical signal by means of an internal CCD sensor and then applied to the signal processing unit 60. Then, the signal processing unit 60 converts the image signal into digital image data and outputs the digital image data to the image processing unit 70. Thereafter, the digital image data are displayed on the display unit 80.

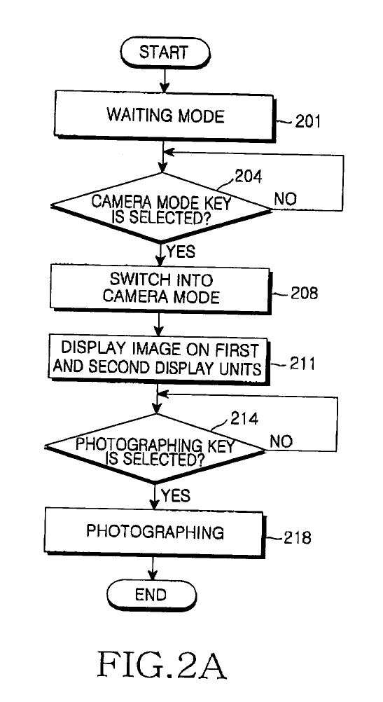

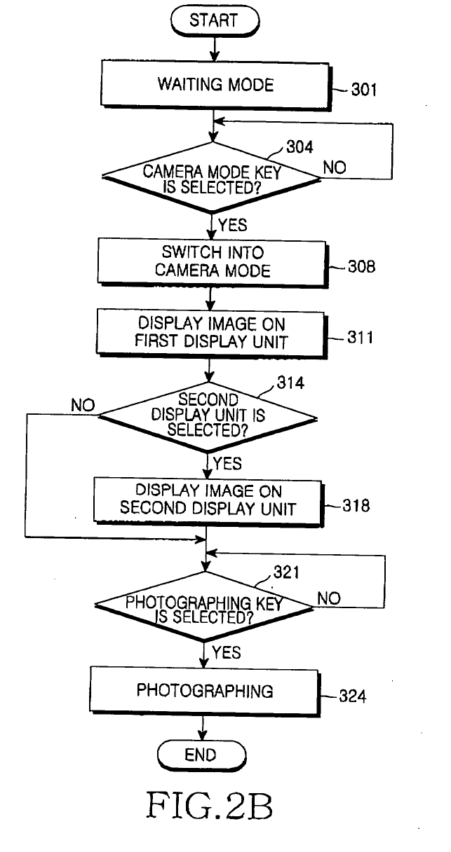

FIG. 2A is a flowchart illustrating a method for simultaneously transmitting an image to the first display unit and the second display unit in the portable terminal according to an embodiment of the present invention.

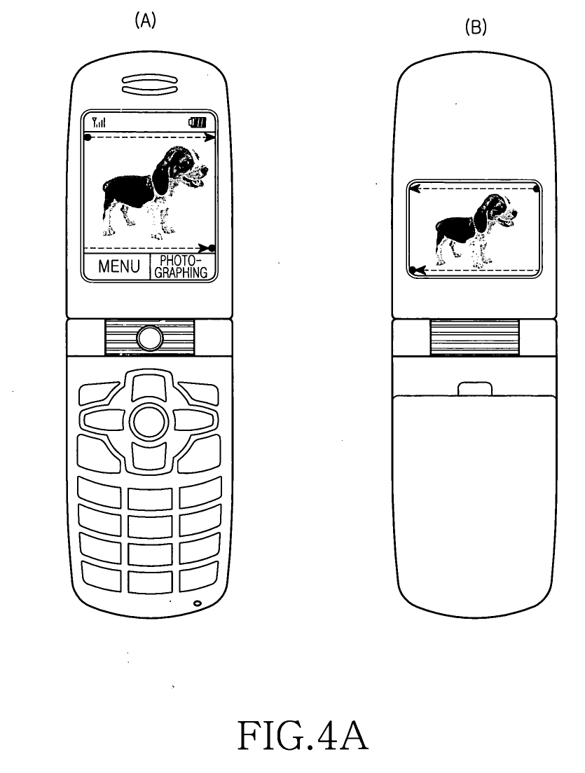

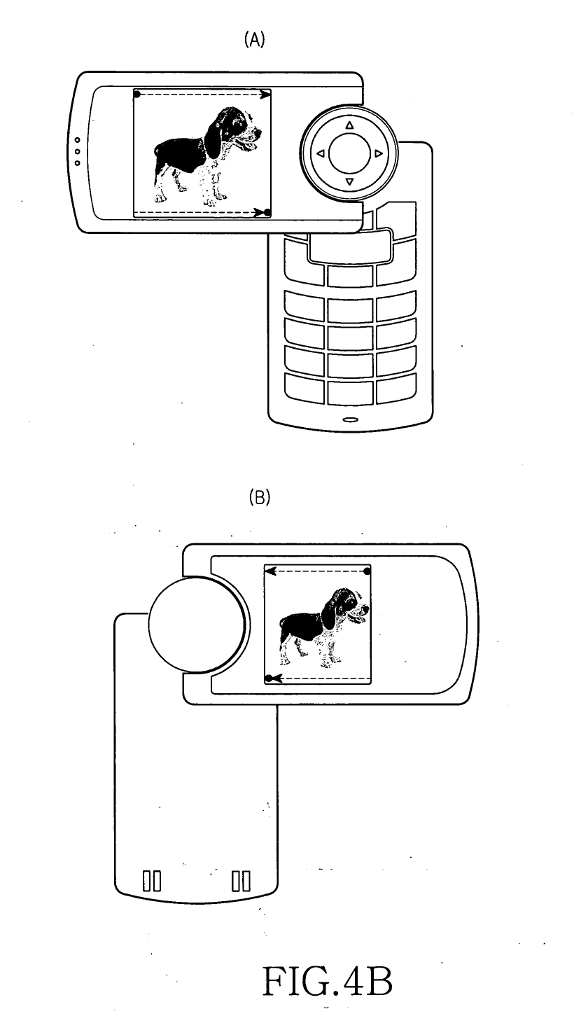

Hereinafter, the method for transmitting the image data will be described in detail with reference to FIG. 1 and FIGS. 4A and 4B according to an embodiment of the present invention.

In a waiting mode of step 201, if a user presses a camera mode key by using the key pad 27, the control unit 10 detects the pressing of the camera mode key in step 204. Herein, the camera mode key may be selected on a menu displayed by means of a menu key or in navigation keys of the key pad 27 in step 208.

The control unit 10 switches into a camera mode and enters into a preview mode. In step 211, the control unit 10 transmits an image signal acquired by the camera 50 to the image processing unit 70 through the signal processing unit 60 as image data. The control unit 10 controls the displayer driving unit 76 for the first display unit and the displayer driving unit 77 for the second display unit so as to drive the first display unit 81 and the second display unit 82. In addition, the control unit 10 controls the image processing unit 70 so as to notify a start address value and an end address value for output of the acquired image data to the first display unit 81. Additionally, the control unit 10 controls the image processing unit 70 so as to indicate a start address value and an end address value for output of the acquired image data to the first display unit 81 and indicate reverse output of the image data to the second display unit 82. Also, the control unit 10 controls the image processing unit 70 to display the acquired image on the first display unit 81 in a normal direction (in up, down, left and right directions) by designating the left uppermost address value on the first display unit 81 as a start address value and the right lowermost address value on the first display unit 81 as an end address as shown through reference numeral A of FIG. 4A and A of FIG. 4A. In addition, the control unit 10 controls the image processing unit 70 to display the acquired image upward, downward, rightward, and leftward (that is, in left-right reversed directions) on the second display unit 82 by designating the right uppermost address value on the display unit 82 as a start address value and the left lowermost address value on the first display unit 81 as an end address as shown through reference numerals B of FIG. 4A and B of FIG. 4B.

After that, if the user selects the photographing key through the key pad 27, the control unit 10 detects the selection of the photographing key in step 214 and takes a photograph in step 218.

FIG. 2B is a flowchart illustrating a method for selectively sending an image to the first display unit and the second display unit in the portable terminal according to an embodiment of the present invention.

Hereinafter, the method according to the present invention will be described in detail with reference to FIG. 1 and FIGS. 4A and 4B.

In a waiting mode of step 301, if a user presses the camera mode key through the key pad 27, the control unit 10 detects the pressing of the camera mode key in step 304. Herein, the camera mode key may be selected on a menu displayed by means of a menu key or in navigation keys of the key pad 27.

The control unit 10 switches into the camera mode so as to enter into the preview mode in step 308. The control unit 10 transmits the image signal acquired by the camera 50 to the image processing unit 70 through the signal processing unit 60 as image data in step 311. The control unit 10 controls the displayer driving unit 76 for the first display unit so as to drive the first display unit 81. In addition, the control unit 10 controls the image processing unit 70 so as to indicate a start address value and an end address value for output of the acquired image data to the first display unit 81. In addition, the control unit 10 controls the image processing unit 70 to display the acquired image on the first display unit 81 in a normal direction (in up, down, left, and right directions) by designating the left uppermost address value on the first display unit 81 as a start address value and the right lowermost address value on the first display unit 81 as an end address as shown through reference numeral A of FIG. 4A and A of FIG. 4B.

After that, if the user presses the display mode key for the second display unit 82 through the key pad 27, the control unit 10 detects the pressing of the display mode key in step 314 and controls the displayer driving unit 77 for the second display unit 82 so as to drive the second display unit 82 in step 318. Herein, the display mode key for the second display unit 82 may comprise a side key or a specific menu key. In addition, the control unit 10 controls the image processing unit 70 so as to indicate a start address value and an end address value for output of the acquired image data and indicate reverse output of the image data to the second display unit 82. In addition, the control unit 10 controls the image processing unit 70 to display the acquired image upward, downward, rightward, and leftward (that is, in left-right reversed directions) on the second display unit 82 by designating the right uppermost address value on the second display unit 82 as a start address value and the left lowermost address value on the second display unit 82 as an end address as shown through reference numerals B of FIG. 4A and B of FIG. 4B.

After that, if the user selects the photographing key through the key pad 27, the control unit 10 detects the selection of the photographing key in step 321 and takes a photograph in step 324.

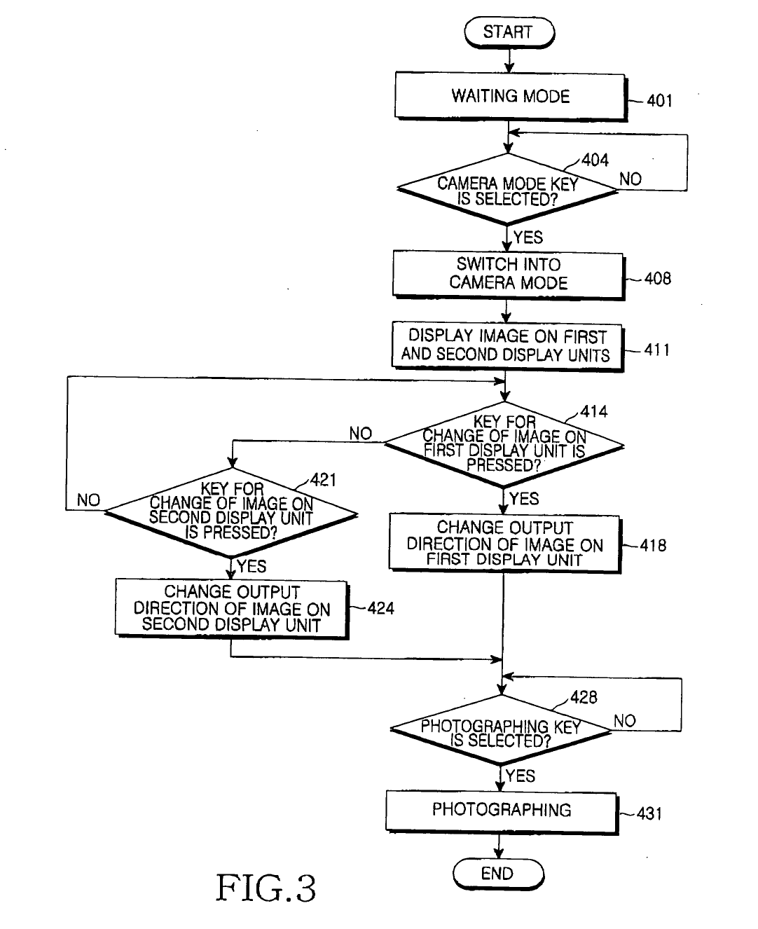

FIG. 3 is a flowchart illustrating a method for selectively sending an image to the first display unit and the second display unit based on the changed address values in the portable terminal according to an embodiment of the present invention.

Hereinafter, the method according to the present invention will be described in detail with reference to FIG. 1 and FIGS. 4A and 4B.

In a waiting mode of step 401, if a user presses the camera mode key through the key pad 27, the control unit 10 detects the pressing of the camera mode key in step 404. Herein, the camera mode key may be selected on a menu displayed by means of a menu key or in navigation keys of the key pad 27.

The control unit 10 switches into a camera mode and enters into a preview mode in step 408. In step 411, the control unit 10 transmits an image signal acquired by the camera 50 to the image processing unit 70 through the signal processing unit 60 as image data. The control unit 10 controls the displayer driving unit 76 for the first display unit and the displayer driving unit 77 of the second display unit so as to drive the first display unit 81 and the second display unit 82. In addition, the control unit 10 controls the image processing unit 70 so as to indicate a start address value and an end address value for output of the acquired image data to the first display unit 81. In addition, the control unit 10 controls the image processing unit 70 so as to indicate a start address value and an end address value for output of the acquired image data and indicate reverse output of the image data to the second display unit 82 such that the image displayed on the second display unit 82 is a reverse image of the image displayed on the first display unit 81. In addition, the control unit 10 controls the image processing unit 70 to display the acquired image data from the start address in up, down, left, and right directions on the first display unit 81. The control unit 10 also controls the image processing unit 70 to display the acquired image data upward, downward, rightward, and leftward (that is, in left-right reversed directions) on the second display unit 82.

After that, first, if the user presses a key used for changing image data of the first display unit, the control unit 10 detects the pressing of the key in step 414. In step 418, the control unit 10 controls the image processing unit 70 to change the start address value, the end address value, and an output direction of the image data which are being displayed on the first display unit 81, so that the first display unit 81 may display a reversed image or a left-right reversed image. Herein, the key used for changing the image data of the first display may include a side key or a specific menu key.

Second, if the user presses a key used for changing image data of the second display unit, the control unit 10 detects the pressing of the key in step 421. In step 424, the control unit 10 controls the image processing unit 70 to change the start address value, the end address value, and an output direction of the image data which are being displayed on the second display unit 82, so that the second display unit 82 may display a reversed image or a left-right reversed image. Herein, the key used for changing the image data of the second display may include a side key or a specific menu key.

Thereafter, if the user selects the photographing key through the key pad 27, the control unit 10 detects the selection of the photographing key in step 428 and takes a photograph in step 431.

As described above, according to an embodiment of the present invention, an image photographed in a portable terminal comprising a camera is displayed on a first display unit positioned at the inner side of the portable terminal and a second display unit positioned at the outer side of the portable terminal such that the other party (a subject) as well as a user of the portable terminal may view the image being photographed as well as photographed from their respective positions, thereby preventing repeated photograph attempts by the user based on the photograph state, thus increasing the user's convenience.

While the invention has been shown and described with reference to certain embodiments thereof, it will be understood by those skilled in the art that various changes in form and details may be made therein without departing from the spirit and scope of the invention. Consequently, the scope of the invention should not be limited to the embodiments, but should be defined by the appended claims and equivalents thereof.

1. A method for displaying an image in a portable terminal comprising two display units, the method comprising the steps of:
when a camera mode is selected, receiving an image; and
displaying the received image on a first display unit and a reverse image of the received image on a second display unit.

2. The method as claimed in claim 1, wherein the received image is simultaneously displayed on both the first display unit and the second display unit.

3. The method as claimed in claim 1, wherein the step of displaying the received image on the first display unit and the second display unit comprises the steps of:
displaying the received image on the first display unit; and
when the second display unit is selected, displaying the received image on the second display unit.

4. The method as claimed in claim 1, wherein, when the image is a first normal direction image displayed on the first display unit, a second normal direction image is displayed on the second display unit, the second normal direction image being obtained through a left-right reverse of the first normal direction image.

5. The method as claimed in claim 1, wherein, when the image is a first normal direction image displayed on the second display unit, a second normal direction image is displayed on the first display unit, the second normal direction image being obtained through left-right reverse of the first normal direction image.

6. The method as claimed in claim 1, wherein, while the received image is displayed on the first display unit and the second display unit, the image on the first display unit is displayed as a reverse image or a left-right reverse image if a key used for changing the image on the first display unit is pressed, and the image on the second display unit is displayed as a reverse image or a left-right reverse image if a key used for changing the image on the second display unit is pressed.

7. The method as claimed in claim 1, further comprising:
displaying the received image on the second display when a key is pressed on the portable terminal.

8. The method as claimed in claim 7, wherein the key for displaying the received image is disposed on at least one of a keypad and a touchscreen.

9. An apparatus for displaying an image in a portable terminal, comprising:
a memory for storing images;
an input device for entering commands for the portable terminal;
a controller for receiving the image when a camera mode is selected and displaying a received image on a first display unit and displaying a reverse image of the received image on a second display unit.

10. The apparatus as claimed in claim 9, wherein the received image is simultaneously displayed on both the first display unit and the second display unit.

11. The apparatus as claimed in claim 9, wherein the controller displays the received image on the first display unit and, when the second display unit is selected, displays the received image on the second display unit.

12. The apparatus as claimed in claim 9, wherein, when the image is a first normal direction image displayed on the first display unit, a second normal direction image is displayed on the second display unit, the second normal direction image being obtained through a left-right reverse of the first normal direction image.

13. The apparatus as claimed in claim 9, wherein, when the image is a first normal direction image displayed on the second display unit, a second normal direction image is displayed on the first display unit, the second normal direction image being obtained through left-right reverse of the first normal direction image.

14. The apparatus as claimed in claim 9, wherein, while the received image is displayed on the first display unit and the second display unit, the image on the first display unit is displayed as a reverse image or a left-right reverse image if a key used for changing the image on the first display unit is pressed, and the image on the second display unit is displayed as a reverse image or a left-right reverse image if a key used for changing the image on the second display unit is pressed.

15. The apparatus as claimed in claim 9, the controller displays the received image on the second display when a key is pressed on the portable terminal.

16. The apparatus as claimed in claim 15, wherein the key for displaying the received image is disposed on at least one of a keypad and a touchscreen.
